(19) United States
(12) Patent Application Publication
(10) Pub. No.: US 2024/0282904 A1
(43) Pub. Date: Aug. 22, 2024

(54) METHOD FOR MANUFACTURING ELECTRODES FOR STORAGE BATTERY CELLS, DEVICE FOR MANUFACTURING ELECTRODES FOR STORAGE BATTERY CELLS, AND STORAGE BATTERY

(71) Applicant: Volkswagen Aktiengesellschaft, Wolfsburg (DE)

(72) Inventors: Ludger Busswinkel, Braunschweig (DE); Sebastian Reuber, Dresden (DE); Roland Schmidt-Lobach, Hoersingen (DE); Sven Schopf, Braunschweig (DE)

(73) Assignee: Volkswagen Aktiengesellschaft, Wolfsburg (DE)

(21) Appl. No.: 18/583,665

(22) Filed: Feb. 21, 2024

(30) Foreign Application Priority Data
Feb. 21, 2023 (DE) 10 2023 201 530.7

(51) Int. Cl. H01M 4/04

(52) U.S. Cl. CPC H01M 4/0409; H01M 4/0435

(57) ABSTRACT

A method for manufacturing electrodes for storage battery cells, wherein a material web is coated at least on a first side with a coating material, and the coating material is deposited on the first side using a first application roller.

This nonprovisional application claims priority under 35 U.S.C. § 119(a) to German Patent Application No. 10 2023 201 530.7, which was filed in Germany on Feb. 21, 2023, and which is herein incorporated by reference.

### BACKGROUND OF THE INVENTION

### Field of the Invention

The invention relates to a method for manufacturing electrodes for storage battery cells. The invention further relates to a device for manufacturing electrodes for storage battery cells, and to a storage battery.

### Description of the Background Art

Storage batteries such as lithium-ion storage batteries are prevalent at the present time. They are used in motor vehicles, among other things, and are utilized there, for example, as so-called drive batteries, i.e., as energy stores for supplying power to electric drive machines.

A storage battery of this type frequently has multiple interconnected storage battery cells, the storage battery cells customarily having an essentially uniform design. In particular for lithium-ion storage batteries, each storage battery cell typically has two electrodes, a separator, and an electrolyte.

### SUMMARY OF THE INVENTION

It is therefore an object of the invention to provide an advantageous method for manufacturing electrodes for storage battery cells, an advantageously designed device for manufacturing electrodes for storage battery cells, and an advantageously designed storage battery.

The method according to an example of the invention is used in the manufacture of electrodes for storage battery cells and is accordingly designed for this purpose. The method, i.e., the method according to the invention, is preferably carried out using the device according to the invention, which is designed and configured for manufacturing electrodes for storage battery cells according to the method according to the invention. By use of the method, electrodes for storage battery cells, more preferably storage battery cells, and in particular storage batteries, according to the invention are then manufactured, wherein each storage battery, i.e., each storage battery according to the invention, has at least one storage battery cell with at least one electrode that is manufactured using the method according to the invention.

In most cases, however, the storage battery according to the invention has multiple interconnected storage battery cells, the storage battery cells hereby generally having an essentially uniform design. Each storage battery cell advantageously has two electrodes, a separator, and an electrolyte. In addition, the storage battery is preferably designed as a lithium-ion storage battery. Depending on the application, the storage battery is designed, for example, for use in a motor vehicle, for example as an energy store for supplying power to an electric drive machine.

For manufacturing electrodes for storage battery cells, in the course of carrying out the method according to the invention a coated material web is now produced. Thus, in the course of carrying out the method, i.e., the method according to the invention, processing of a material web takes place.

Such a material web is typically a prefabricated web material which generally includes a metal foil, for example a copper foil or an aluminum foil, or which is formed by such a metal foil. In addition, the material web is typically present as a so-called continuous material or roller material. The material web has a length that is significantly greater than its width or thickness or height. The material web preferably has a width whose value is greater than or equal to 400 mm and in particular greater than or equal to 500 mm, i.e., a width of 600 mm, for example.

During the processing, the material web is coated on at least one first side with a coating material. The coating material contains an active material, namely, a so-called electrode active material or electrode material for short. Such active materials are known in principle. Examples of active materials for forming negative electrodes are graphite and silicon. Examples of electrode materials for forming positive electrodes are lithium nickel-manganese-cobalt oxide (NMC), lithium iron phosphate (LFP), and lithium nickel-cobalt-aluminum oxide (NCA). Depending on the application, the coating material also contains a so-called binder and/or a so-called conductive additive.

The coating material can be deposited on or applied to the first side using a first application roller. In particular, a direct transfer of the coating material from the first application roller to the material web takes place. Thus, the coating material is “rolled onto” the material web in a manner of speaking.

The first application roller can be supplemented by a counter roller, the first application roller and the counter roller generally rotating in opposite directions during operation. In this case, for the coating the material web is guided through between the first application roller and the counter roller, and in a space between the first application roller and the counter roller the coating material is deposited on or applied to the first side of the material web via the first application roller.

Furthermore, the coating of the material web, i.e., the deposition or application of the coating material on/to the material web, preferably takes place without solvent, in particular without a liquid solvent. That is, for example the production of a suspension that contains the active material and a liquid solvent is preferably dispensed with. Due to dispensing with a liquid solvent, in the method described here this is also referred to as dry electrode manufacture or even solvent-free electrode manufacture.

In addition, a method variant is preferred in which the coating material is present as a powder or powder mixture, and in particular is also applied or deposited as a powder on/to the first application roller. It is also advantageous when the coating material that is applied to the first application roller is subsequently compacted. The compaction preferably takes place prior to the deposition or application of the coating material on/to the material web.

For example, the coating material can be compacted on the first application roller via a first pressing roller. The first application roller is thus supplemented by the first pressing roller, the first application roller and the first pressing roller generally rotating in opposite directions during operation. In this case, the coating material is guided through between the first application roller and the first pressing roller, and the coating material is compacted in a space between the first application roller and the first pressing roller.

It is also advantageous when the coating material is deposited on the first side of the material web over a predefined first coating width. The first coating width corresponds to the provided width of the coating on the first side of the material web, i.e., the provided extent of the coating transverse to the longitudinal direction of the material web.

The provided extent of the coating material transverse to the longitudinal direction is preferably also predefined on the first application roller, and thus typically even before the coating material is applied to the material web. In addition, the provided extent of the coating material transverse to the longitudinal direction is preferably predefined, in that the extent of the coating material transverse to the longitudinal direction on the first application roller is reduced to the predefined first coating width. That is, the coating material is generally applied to the first application roller with a preliminary extent transverse to the longitudinal direction, and this preliminary extent is subsequently reduced to the first coating width. The preliminary extent transverse to the longitudinal direction is then advantageously greater than the first coating width. It is also advantageous when the preliminary extent is reduced to the first coating width via at least one mechanical element, i.e., in particular a mechanical element that acts in the manner of a knife and/or scraper.

The first coating width can be predefined via a crush cut knife, and in particular via a crush cut on the first application roller. Such a crush cut knife is typically a knife disk having a wedge-shaped cutting edge, for example. This knife disk then preferably rests against the first application roller and squeezes the coating material apart along a provided edge.

In an example, for the crush cut knife a contact pressure with which the crush cut knife rests against the first application roller is predefined. Depending on the example, the contact pressure can be predefined with the aid of a spring element, for example. Alternatively, the contact pressure is predefined via a pneumatic system and is thus pneumatically adjustable.

In addition, it is advantageous when the first coating width is predefined with the aid of a scraper with which coating material is scraped off the first application roller. For example, the scraper may supplement the above-mentioned crush cut knife, so that the excess coating material that is removed by the crush cut knife via the crush cut is scraped off the first application roller via the scraper.

Furthermore, two crush cut knives of the type described above can be used to predefine the first coating width. The two crush cut knives are then advantageously spaced apart from one another, viewed in the direction of a longitudinal axis of the first application roller, wherein the distance between the two crush cut knives predefines the first coating width. In one advantageous refinement, a scraper of the type described above is also assigned to each of the two crush cut knives.

Thus, according to the method presented here, the coating material is preferably initially applied to the first application roller over a width that is greater than the provided width of the coating on the first side of the material web. The width on the first application roller is subsequently reduced to the first coating width, and the coating material is ultimately applied with the first coating width to the material web.

With the reduction, a targeted adjustment of the coating width, i.e., in particular a type of edge trimming, advantageously takes place. The reduction preferably takes place via a crush cut, i.e., with the aid of the above-mentioned crush cut knife. According to an alternative variant, the reduction takes place via a so-called kiss cut or roller punching.

It is also advantageous when knives with rectangular blades (razor blades) are used for the reduction. Alternatively, circular knives that are driven or used in drag mode, for example, are employed.

Regardless, the distance between the first application roller and the knives used is preferably adjusted to micron accuracy, and is thus predefined to micron accuracy.

Furthermore, in the course of a reduction of the width as described above, coating material is typically removed from the first application roller. The coating material removed from the first application roller is more preferably collected or suctioned off, in particular so that it does not fall off in an uncontrolled manner. It is advantageous when the collected or suctioned-off coating material is reused.

In addition, the material web typically has the above-mentioned first side as well as an oppositely situated second side. Depending on the application, in addition to the first side the second side is also coated with a coating material of the type described above, in particular with the same coating material as for the first side.

The coating material is advantageously deposited on the second side of the material web using a second application roller. In this case, the second application roller is then typically also used as an above-described counter roller for the first application roller, and the first application roller is analogously used as a counter roller for the second application roller.

Furthermore, the second application roller can also be supplemented by a pressing roller, namely, a second pressing roller. Analogously to the first pressing roller, the coating material, in particular the coating material on the second application roller, is then also compacted via the second pressing roller.

The coating material can be deposited on the second side of the material web over a predefined second coating width. The second coating width is preferably predefined as previously described for the first coating width.

In summary and in other words, a concept is presented here which allows electrode manufacture, and in particular solvent-free or dry electrode manufacture. The following are of particular importance:

The electrode manufacture preferably takes place using a number of rollers, in particular using a number of calender rollers, typically at least one roller-supported electrode film made of coating material being applied to a web material to form a coating. The application typically takes place in a calender gap between two rollers.

The concept also preferably allows exact predefinition/exact adjustment of the width of the coating. For this purpose, each electrode film edge is preferably formed via a crush cut, each crush cut typically being made directly on one of the rollers in order to ultimately create an exact coating width with a consistently high-quality coating edge. It is further preferred that each crush cut is supplemented by a doctor blade process for removing excess coating material at the electrode film edge.

It is further preferred that the excess coating material is either collected or suctioned off directly into a container and conveyed into a separate container. From there, the excess coating material is preferably resupplied directly to one of the preceding process steps (direct recycling).

The positions and pressing forces of the crush cut knives used and of the doctor blades used are preferably variably set according to process requirements. For this purpose, pneumatic activation can be used to ensure a consistent setting force and position.

As an option, optical edge recognition of the coating width is provided which further preferably allows the exact positioning of the crush cut knives and of the doctor blades via a closed-loop control.

Also, instead of a crush cut, a so-called kiss cut as with roller punching can be used, in which a knife has a defined distance of several microns from the counter body (calender roller). For example, a rectangular blade (razor blade) or a circular knife (driven or in drag mode) is then used as a knife.

As an alternative to the pneumatic pressing, mechanical pressing via a spring element is provided.

The concept provides at least the following advantages:

A cutting force may be adjusted in a targeted manner by use of a crush cut, with pneumatic pressing of a crush cut knife onto a roller/calender roller.

The pneumatic pressing allows a consistent pressing force that is precisely settable and controllable.

The cutting position may be exactly and reproducibly set, and by use of a coupled scraper/doctor blade the cut-off edge rim may be directly removed from the roller/calender roller.

The crush cut ensures a reproducibly settable cutting edge quality with a defined pressing force.

The use of a kiss cut has the advantage that there is no contact between the knife and the roller, thus prolonging the service life of the blade and reducing the wear on the calender roller (running marks).

By use of the method, the coating edge may be exactly positioned, and manufacturing may be carried out with the required product quality.

Excess material may be removed and resupplied directly to the preceding process step.

Thus, as described above, in the course of carrying out the method according to the invention a coated material web is produced. The production of the coated material web advantageously takes place in a portion of the method for manufacturing electrodes for storage battery cells. This method portion can be carried out via a processing station that is part of the device according to the invention for manufacturing electrodes for storage battery cells.

In a further portion of the method, the coated material web is then advantageously cut to size, with electrodes being withdrawn or cut out. The further method portion is preferably carried out via a further processing station of the device according to the invention.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a side view of a device for manufacturing electrodes for storage battery cells, and

FIG. 2 shows a view of the device from below.

### DETAILED DESCRIPTION

A method described below by way of example is used for manufacturing electrodes for storage battery cells. The method has two method portions, namely, a method portion for coating and a method portion for cutting to fit. In the course of carrying out the method portion for coating, a coated material web 2 is produced by coating a prefabricated material web 4 with a coating material 6 containing graphite, for example. In the course of carrying out the method portion for cutting to fit, the coated material web 2 is then cut to size, with electrodes being withdrawn or cut out.

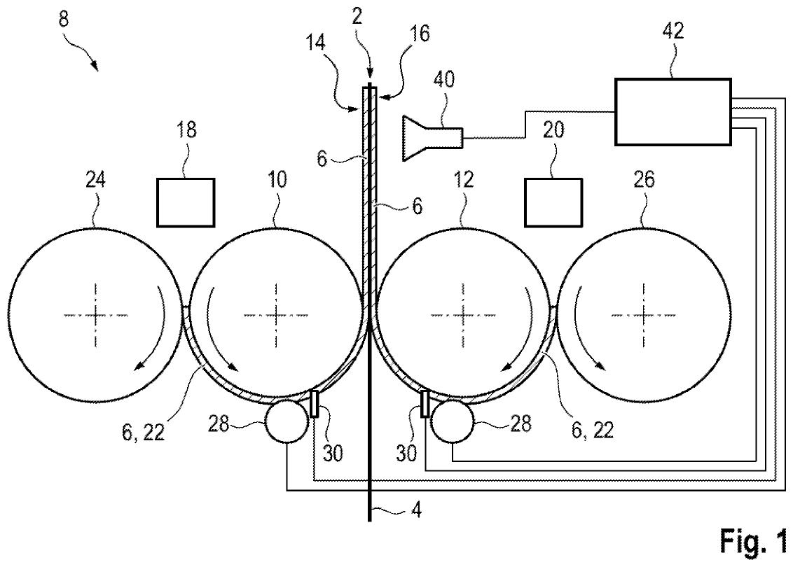

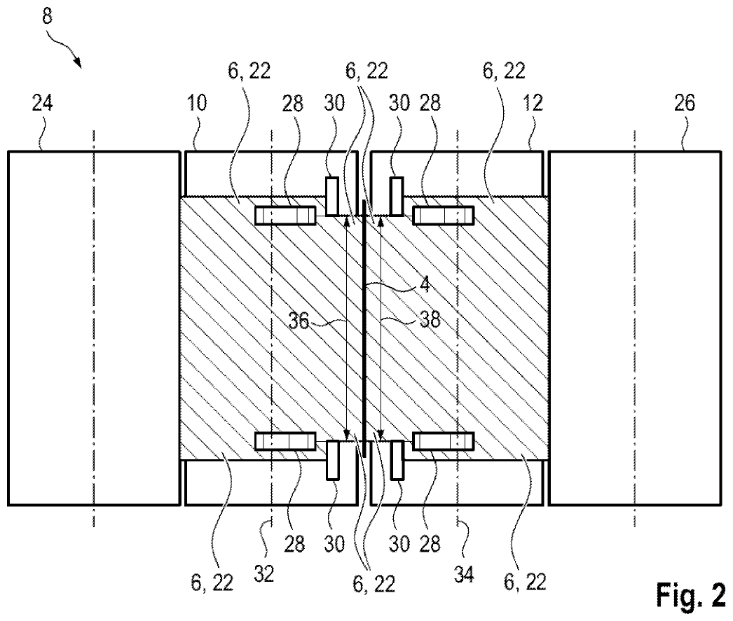

The method portion for coating is described in greater detail below. This method portion is carried out using a device 8, which is depicted in simplified form in FIGS. 1 and 2. The device is shown in a side view in FIG. 1 and in a view from below in FIG. 2.

The device 8 may have two application rollers 10, 12, namely, a first application roller 10 and a second application roller 12. During operation of the device 8, the coating material 6 is applied to a first side 14 of the material web 4 using the first application roller 10. A direct transfer of the coating material 6 from the first application roller 10 to the material web 4 takes place. Thus, the coating material 6 is “rolled onto” the material web 4 in a manner of speaking. The coating material 6 is analogously applied to a second side 16 of the material web 4 using the second application roller 12. Here as well, the coating material 6 is “rolled onto” the material web 4 in a manner of speaking.

The two application rollers 10, 12 together form a roller pair. The application rollers are spaced a small distance apart from one another, and rotate in opposite directions during operation. The material web 4 is guided through between the two application rollers 10, 12, and in a space between the two application rollers 10, 12 is coated on both sides with the coating material 6. The two application rollers 10, 12 therefore act as so-called calender rollers, in a manner of speaking.

The material web 4 is typically a prefabricated web material that is generally formed by a metal foil, for example a copper foil or an aluminum foil. The material web 4 is preferably present as a so-called continuous material or roller material which is fed to the two application rollers 10, 12 in a quasi-continuous manner.

The coating material 6 that is deposited on the material web 4 by the application rollers 10, 12 is applied to the application rollers 10, 12 beforehand. For this purpose a feed unit 18, 20 is respectively associated with each application roller 10, 12. In the feed units 18, 20 the coating material 6 is present as a powder, and is also applied in powder form to the application rollers 10, 12. The use of a liquid solvent for the deposition is thus dispensed with.

The coating material 6 is thus now applied as a powder and is subsequently compacted to form a film 22, which adheres to the respective application roller 10, 12 until it is transferred onto the material web in the space between the application rollers 10, 12. This takes place at both application rollers 10, 12.

The compaction takes place via two pressing rollers 24, 26, a first pressing roller 24 being associated with the first application roller 10 and a second pressing roller 26 being associated with the second application roller 12. In both cases the application roller 10, 12 and the associated pressing roller 24, 26 form a roller pair whose rollers are spaced a small distance apart from one another and rotate in opposite directions during operation.

Furthermore, two crush cut knives 28 are associated with each application roller 10, 12, and a scraper 30 is assigned to each crush cut knife 28. The device 8 thus has four crush cut knives 28 and four scrapers 30.

The two crush cut knives 28 of each application roller 10, 12 are spaced apart from one another, viewed in the direction of a longitudinal axis 32, 34 of the associated application roller 10, 12. The particular width of the coating is then predefined by the corresponding distance between the two crush cut knives 28, i.e., a first coating width 32 on the first side 14 of the material web 4 and a second coating width 34 on the second side 16 of the material web 4. That is, each crush cut knife 28 via a crush cut forms a boundary which initially delimits the particular film 22 on the respective application roller 10, 12, and thus ultimately delimits the width of the particular coating on the respective side of the material web 6.

As is apparent from FIG. 2, a uniform width for the coatings on the two sides 14, 16 of the material web 6 is predefined, and the first coating width 32 on the first side 14 of the material web 4 thus corresponds to the second coating width 34 on the second side 16 of the material web 4.

The excess coating material 6 extending beyond the respective boundary is scraped off the particular application roller 10, 12 using the assigned scraper 30. The scraped-off coating material 6 is then preferably resupplied to the feed units 18, 20 and ultimately reused, in a manner not illustrated in greater detail.

As indicated in FIG. 1, the device 8 preferably also has at least one optical sensor 40. During operation this optical sensor generates sensor data which image the coating on the second side 16, for example. It is further preferred that the sensor data are evaluated using a control and evaluation unit 42 of the device 8. For example, monitoring of the coating width takes place in this way, in particular with the aid of optical edge recognition. According to one advantageous refinement, an instantaneous coating width is then determined and compared to a setpoint value. In addition, control is preferably performed, for example via closed-loop control, in which the positioning of the crush cut knives 28 and of the scrapers 30 is readjusted.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for manufacturing electrodes for storage battery cells, the method comprising:
coating a material web at least on a first side with a coating material; and
depositing the coating material on the first side using a first application roller.

2. The method according to claim 1, wherein the coating material is deposited without solvent.

3. The method according to claim 1, wherein the coating material is applied as a powder to the first application roller.

4. The method according to claim 1, wherein the coating material applied as a powder to the first application roller is compacted.

5. The method according to claim 4, wherein the coating material applied as a powder is compacted via a first pressing roller while the coating material is guided through between the first application roller and the first pressing roller.

6. The method according to claim 1, wherein the coating material is deposited on the first side over a predefined first coating width, and wherein the first coating width is predefined on the first application roller via a crush cut knife.

7. The method according to claim 6, wherein the contact pressure of the crush cut knife is pneumatically adjusted.

8. The method according to claim 1, wherein the coating material is deposited on the first side over a predefined first coating width, and wherein the first coating width is predefined via a scraper with which coating material is scraped off the first application roller.

9. A device configured to manufacture electrodes for storage battery cells according to the method according to claim 1.

10. A storage battery that comprises a storage battery cell having at least one electrode that is manufactured by the method according to claim 1.
